(19) United States
(12) Patent Application Publication
(10) Pub. No.: US 2025/0137650 A1
(43) Pub. Date: May 1, 2025

(54) COOLED ELECTRIC HEATING ASSEMBLY

(71) Applicant: Howard S. Mitz, Littleton, NH (US)

(72) Inventor: Howard S. Mitz, Littleton, NH (US)

(21) Appl. No.: 18/742,165

(22) Filed: Jun. 13, 2024

Related U.S. Application Data
(60) Provisional application No. 63/472,933, filed on Jun. 14, 2023.

(51) Int. Cl. F24C 7/08; F24C 15/00; H05B 3/68

(52) U.S. Cl. CPC F24C 7/08; F24C 15/006; H05B 3/68; H05B 2213/07

(57) ABSTRACT

An electric heating element that is cooled by a cooling fluid (such as air, vapor, or liquid) that in coordination with a temperature controller, flows adjacent to the heating element in order to more quickly reduce the heat given off by the heating element. One example of a cooled heating element is in a cooktop assembly where a burner area can be rapidly cooled to allow for more responsive temperature control relative to conventional electric cooktop appliances.

### CROSS-REFERENCE TO RELATED APPLICATION

This application claims priority from United States Provisional Patent Application number 63/472,933 titled “COOLED ELECTRIC HEATING ASSEMBLY”, which was filed on Jun. 14, 2023, which is incorporated fully herein by reference.

### TECHNICAL FIELD

The present invention relates generally to electric heating elements such as used in cooktops, and more particularly, to a heating element that is provided with a cooling mechanism to quickly cool the heating element and provide temperature control once the heating element is turned down or off.

### BACKGROUND INFORMATION

The gas burner is a desired type of cooking burner by professional chefs as well as many home cooks and chefs for its instant responsiveness when heat is turned on and off. However, the gas that is used for cooking is not renewable and causes an increase in indoor pollution.

Conventional electric cooktops provide an alternative cooking appliance that can rely on renewable energy to operate, and does not cause indoor pollution during operation. However, the heating elements used in conventional electric cooktops, with and without a glass ceramic cooktop surface, are slow to heat up and most importantly, slow to cool down, and therefore lack the responsive temperature control offered by gas burners. The slow response time of electric cooktops also poses a safety hazard that can cause severe burns if touched, and can damage items placed on the cooktop or heating element while still hot.

Therefore, there is a need for an electric heating element for use in, for example a cooktop, that can simulate the rapid temperature control of gas-powered burners.

### SUMMARY OF THE INVENTION

The invention described herein is a cooling mechanism for an electric heating element used and described herein, for exemplary purposes only, in an electric cooktop. The cooling mechanism uses temperature controlled or conditioned air or fluid to transfer heat from, and in some examples, to, an electric heating element assembly. In some examples, channels within a heating assembly introduce cooled air to heating elements to pull heat from the heating elements and surrounding surfaces to reduce the time it takes for the heating element and adjacent burner area to cool to a desired temperature.

The summary here is not an exhaustive listing of the novel features described herein, and are not limiting of the claims. These and other features are described in greater detail below in view of the drawings appended hereto.

### BRIEF DESCRIPTION OF THE DRAWINGS

FIG. 1 is an isometric view of an electric cooktop assembly utilizing a cooled heating element assembly according to an embodiment of the invention;

FIG. 2 is a sectional view of the electric cooktop assembly of FIG. 1 taken along line A-A;

FIG. 3 is an exploded view of a portion of the electric cooktop assembly of FIG. 1 according to an embodiment of the invention;

FIG. 4A is a top view of heating assemblies according to an embodiment of the invention;

FIG. 4B is a cross-sectional view of heating elements and air channels according to an embodiment of the invention;

FIG. 5 is an isometric view of a heating element according to another embodiment of the invention;

FIGS. 6A-6D are cross-sectional views of various heating element configurations;

FIG. 7 is a plan view of a system according to an embodiment of the invention;

FIG. 8 is an isometric view of an electric cooktop assembly utilizing a cooled heating element assembly according to an embodiment of the invention;

FIG. 9A is an isometric view of a heating element according to another embodiment of the invention;

FIG. 9B is an isometric view of a magnified portion of the heating element of FIG. 9A;

FIG. 9C is an isometric view of a magnified portion of another embodiment of a heating element;

FIGS. 10A-10C are a sectional views of the electric cooktop assembly of FIG. 8 taken along line B-B;

FIG. 10D is a magnified cross-sectional view of the heating elements and air channels according to an embodiment of the invention;

FIG. 11 is a plan view of heating elements used with another cooking appliance;

FIG. 12 is an isometric view of a heating element used with a cylindrical heating device;

FIG. 13 is a side view of another example embodiment of a heating element; and

FIG. 14 is a top view of a heating element according to another example embodiment.

### DETAILED DESCRIPTION OF THE PREFERRED EXAMPLES

Exemplary embodiments will be described in detail herein and examples of the exemplary embodiments are illustrated in the accompanying drawings. Unless specified otherwise, the same numbers in different accompanying drawings represent the same or similar elements when the accompanying drawings are described hereinafter. The implementation modes described in the following exemplary embodiments do not represent all the implementation modes consistent with the present disclosure. In contrast, they are only examples of devices as recited in the appended claims and consistent with some aspects of the present disclosure.

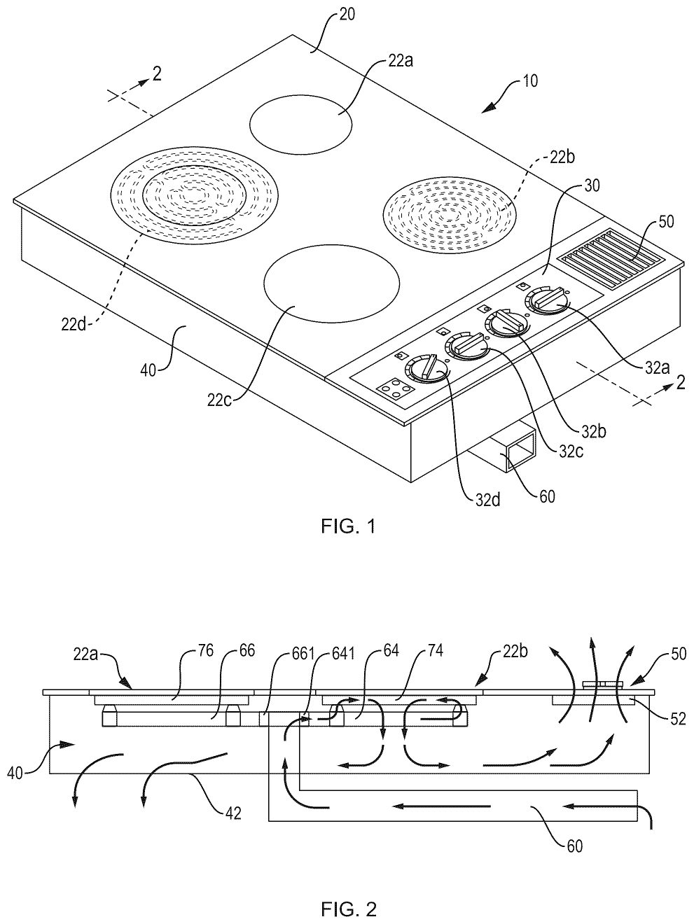

FIG. 1 shows an electric cooktop assembly 10 having a cooktop 20, a control panel 30, and base 40. Cooktop 20 has defined thereon burner areas 22a, 22b, 22c, and 22d that are heated by actuation of heating assemblies (shown in FIG. 2) via respective temperature controllers 32a, 32b, 32c, and 32d on control panel 30. While the example illustrated in FIG. 1 shows a rotary selector, other temperature controller interfaces known in the art are contemplated hereunder, including sliders, capacitive switches, touchscreens, remote computer interfaces, etc.

In some embodiments, air is introduced into the electric cooktop assembly via air inlet 60, and exits the electric cooktop assembly through a vent 50 extending through the cooktop 20. FIG. 2 shows an example of an air flow route through the electric cooktop assembly. Air within inlet 60 is selectively allowed to enter air manifolds 64 or 66 based upon activation of valves 641 and 661 respectively. Air introduced into manifold 64 is directed through heating assembly 74 under burner area 22b, and air introduced into manifold 66 is directed through heating assembly 76 under burner area 22a.

FIG. 2 illustrates an example where valve 661 is closed and 641 is open to allow air to flow into manifold 64 and through heating assembly 74 where it is exhausted to the interior of base 40. In some examples, exhausted air exits the base 40 through vent 50. The movement of air from the base 40 can be assisted by a fan 52 disposed at the vent 50 as shown in FIG. 2 to blow air out of the apparatus 20 or can be disposed upstream from the heating assemblies to push air therethrough. In some examples, exhausted air may exit though an open bottom portion 42 of the base 40.

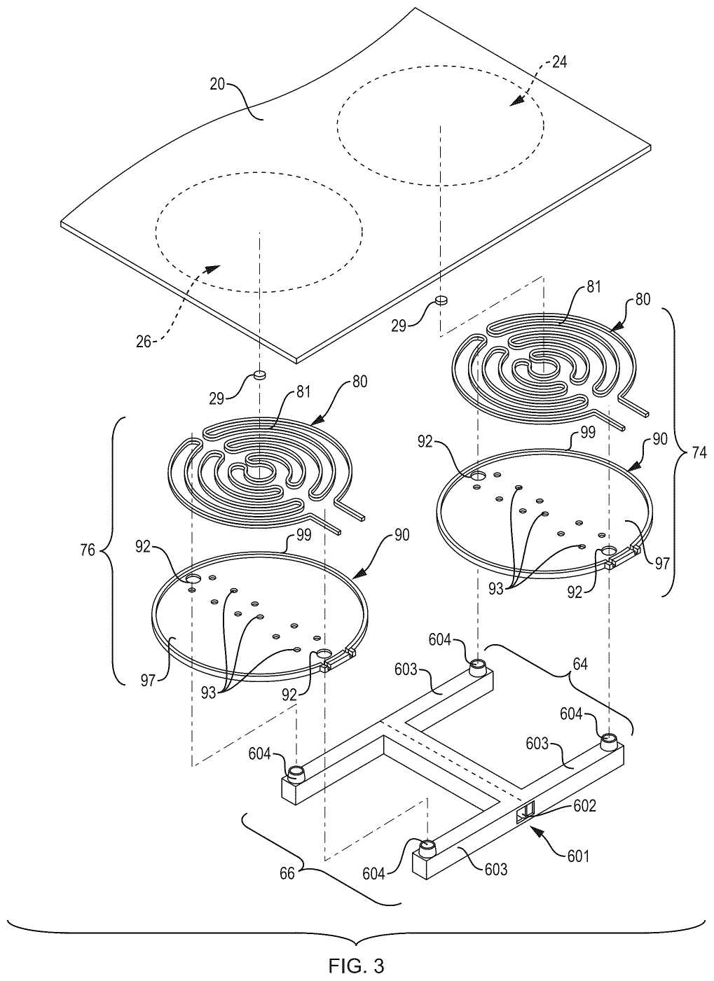

FIG. 3 shows an exploded view of a portion of electric cooktop assembly 10. A portion of cooktop 20 is shown with burner locations 24 and 26, with heater assemblies 74 and 76 and air manifolds 64 and 66 used to heat and cool the respective burners 24 and 26 disposed thereunder. An electric cooktop assembly 10 may, in another embodiment, include only heater elements 80 without a cooktop 20 covering the heating elements 80. Heater assembly 74 includes a heating element 80 and element housing 90. Heating element 80 is formed in a continuous loop with segments 81 substantially concentrically arranged.

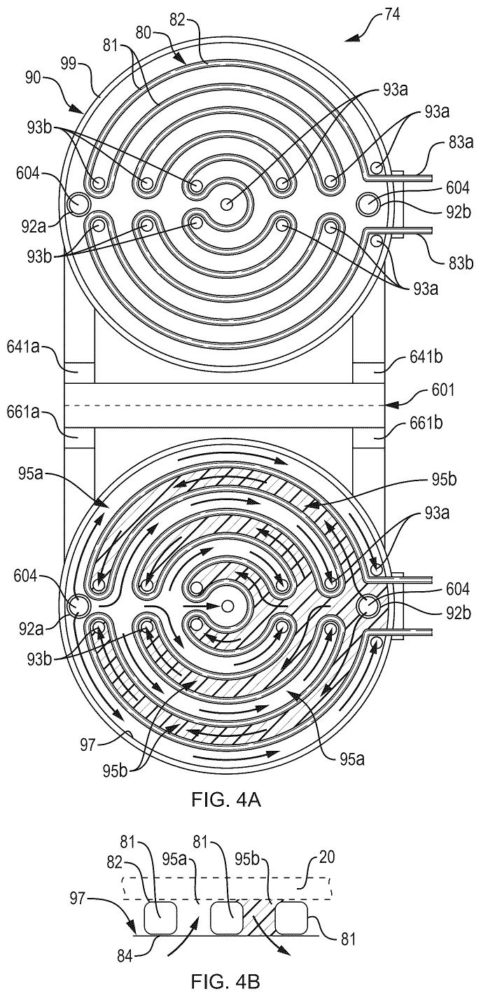

In one embodiment, heating element 80 is placed within element housing 90 such that a bottom surface 84 thereof rests against an upper surface 97 of the element housing and outer wall 99 surrounds the heating element 80 (see FIG. 4B). Element housing 90 further includes air inlets 92 and air outlets 93 that extend through the element housing 90 from the upper surface 97 thereof. Air manifolds 64 and 66 include extensions 603 with nozzles 604 extending upwards from the ends thereof. Air enters the manifolds 64/66 through air inlet 601. Manifolds 64 and 66 are separated by a partition 602 that isolates air flow to each respective side.

In some embodiments, temperature sensors 29 may be disposed adjacent burner locations 24 and 26 on an underside of cooktop 20 to measure the surface temperature at the center of each burner location. In some examples, multiple temperature sensors 29 may be utilized at various positions under each burner location in order to determine an average temperature or temperatures for various zones within each burner. In some examples, flow of air through a heating assembly 74/76 is based on a comparison of the sensed temperature of the burner location and the temperature setting of the temperature controller 32 for that burner location.

FIG. 4 shows a top view of burner assemblies 74 and 76. As shown in reference to burner assembly 74, burner element 80 lies within sidewalls 99 of element housing 90. Heating element 80 contacts the upper surface 97 of element housing 90, and an upper surface 82 of the heating element 80 comes into contact with the bottom surface of the cooktop 20, if provided, in order to transfer heat energy directly thereto through conduction as is well known in the art (see FIG. 4B). In some examples upper surface 82 of heating element 80 is spaced from the bottom surface of cooktop 20 and heats the burner areas through primarily radiation as well as some convection.

Heating element 80 is formed from a continuous element with primary segments 81 being substantially concentric with the outer wall 99 of element housing 90. While the figures herein show circular burner locations, other burner shapes are contemplated hereunder, such as squares, rectangles, ovals, or a combination thereof. In each case the primary segments 81 of the heating element 80 are configured to be substantially concentric with and spaced from the defined perimeter of the burner location. In the example of FIG. 4, primary segments 81 of heating element 80 form nearly semicircular arcs that loop back upon each other to create separate isolated channels 95a and 95b therebetween. At the end of each semicircular channel where the primary segments loop back is an air outlet 93a/93b.

As best seen in reference to heating assembly 76 in FIG. 4, valves 641a and 661a selectively allow air to flow through nozzles 604 and enter channels 95a through air inlet 92a. The introduced air travels between adjacent heating element segments 81 and out of air outlets 93a. As the air travels along channels 95a heat is transferred to air from the four main surfaces that define the channel 95a, specifically, two heating element segments 81 forming sidewalls of the channel 95a (or the outer wall 99 and outermost segment 81 in the case of the outermost channel 95a), the bottom surface of the range top 20 above the channel 95a, and the portion of upper surface 37 of element housing 90 below the channel 95a (see FIG. 4B). Similarly, valves 641b and 661b selectively allow air to flow through nozzles 604 and air inlet 92b and travel along channels 95b and out of air outlets 93b, transferring heat from respective portions of the heating element segments 81, range top 20, and upper surface 97 of element housing 90 that define the channel.

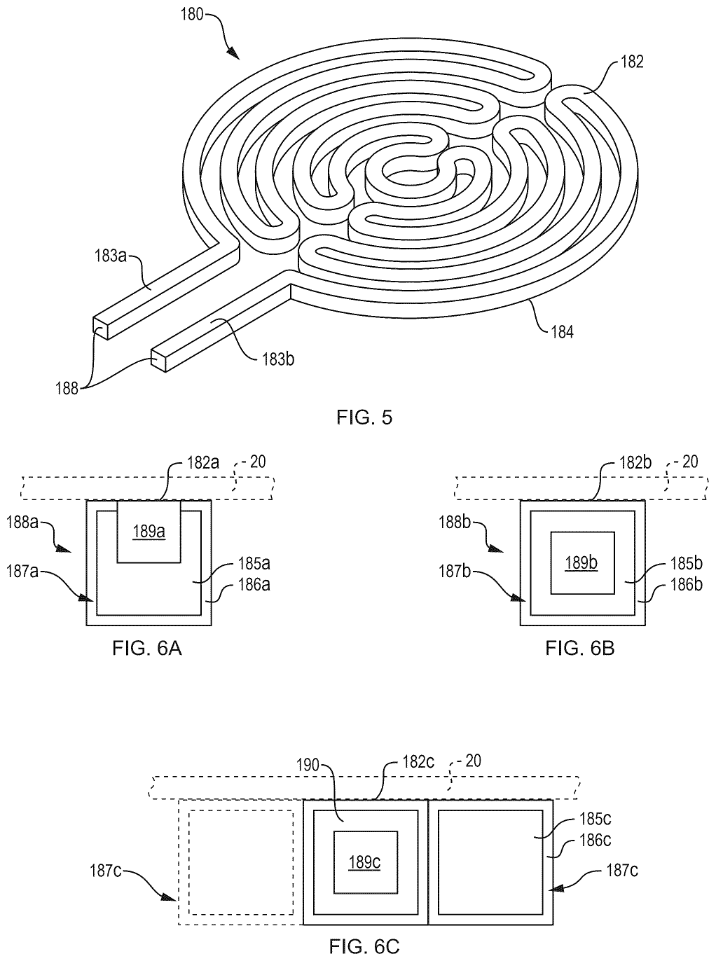

As seen in FIG. 5 heating element 180 can take various forms with various cross sections 188. Similar to heating element 80 previously discussed, heating element 180 includes an upper surface 182 that is adjacent an area to be heated and bottom surface 184 that is adjacent heating element housing. Heating element 180 may include connectors 183A 183B, similar to connectors 83A and 83B of heating element 80, that interface with the range unit 10 leave electrical current used to produce heat within the heating element 180.

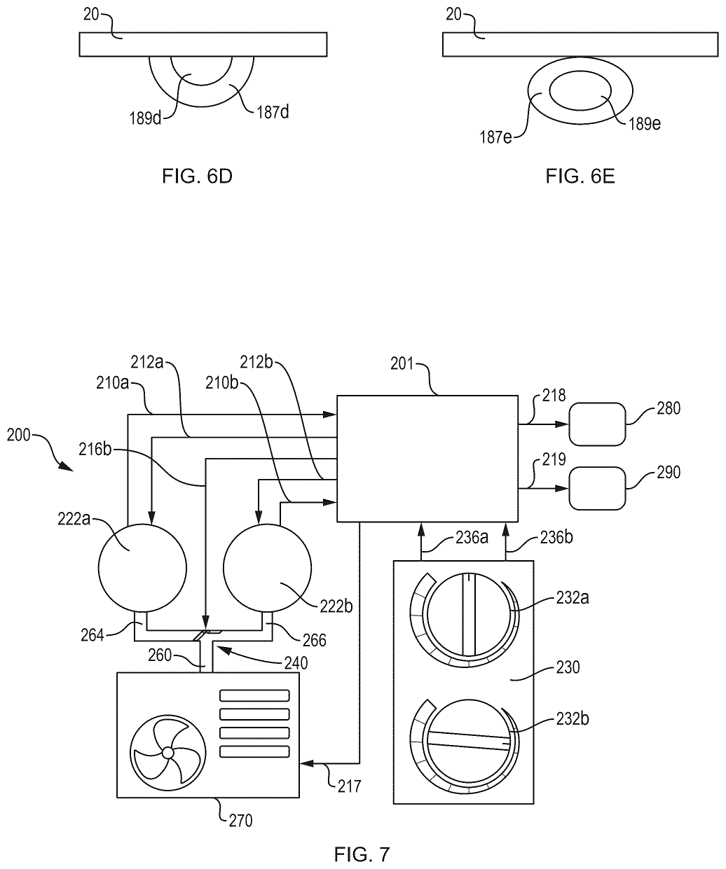

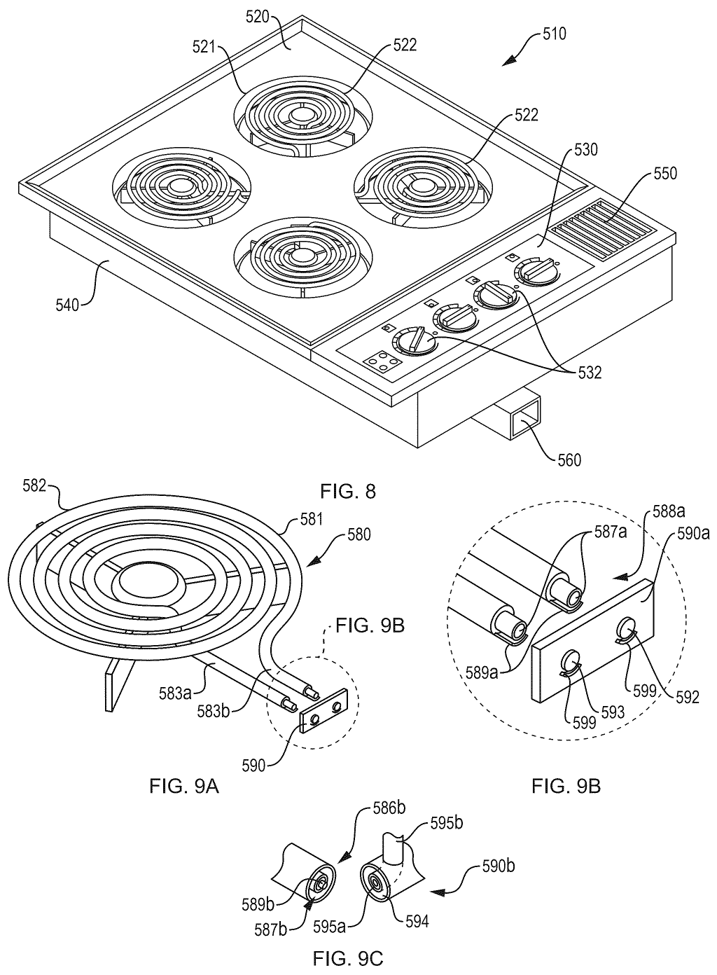

In some examples the electric cooktop assembly 10 has openings through its range top 20 such that a cooking vessel can come in direct contact with the upper surface 82 of heating element 80 (see FIG. 8). FIGS. 6A-6D show various examples of heating element cross-sections that combine a heating core surrounded by or adjacent a separate sealed cooling channel through which air or fluid flows to pull heat from the heating core.

In FIG. 6A, cross-section 188a shows heating core 189a adjacent the top surface 182a of the heating element 180, with cooling channel 187a comprising a channel wall 186a and its interior volume 185a substantially surrounding 3 out of the 4 sides of heating core 189a. This provides for cooling of the heating core 189a as the primary cooling mechanism for an adjacent burner location of cooktop 20 (or a cooking vessel directly if no cooktop is provided).

In FIG. 6B heating core 189b is disposed at the center of cooling channel 187b, with the channel walls 186b and interior volume 185b surrounding all sides of the heating core 189b. The cooling mechanism in this example cools both the cooktop 20 (or a cooking vessel directly if no cooktop is provided) and heating core 189b. While this configuration allows for more efficient cooling compared to the arrangement in cross-section shown in FIG. 6A, the heating core 189b is spaced from the top surface 182b of the heating element 180, which reduces somewhat the heating capabilities of the heating core 189b.

FIG. 6C shows a configuration that resembles the arrangement of FIG. 4A, with a heating core 189c with an upper surface 182c disposed adjacent to the cooktop 20 (or, as shown in the illustrated example, surrounded by a material 190 that provides for efficient heat transfer thereto), with cooling channel 187c on one or both sides of the heating core 189c. This allows for direct cooling of the heating core 189c as well as the cooktop 20 and other surrounding surfaces. Here, however, cooling channel 187c is enclosed by walls 186c, allowing for the use of either air or fluid to circulate through the inner volume 185c.

FIG. 6D shows an arrangement similar to FIG. 6A with a heating core 189d in contact with cooktop 20 and a cooling channel 187d surrounding a lower portion thereof, but has a semicircular cross section which may be preferable in some circumstances. FIG. 6E shows another rounded cross section with heating core 189e completely surrounded by cooling channel 187e. Circular or rounded cross sections generally have the advantage of being more efficient in terms of material costs as well as being more durable in terms of resisting stresses from repeated heating and cooling cycles, as sharp corners present areas that are prone to failure in some circumstances. In some examples, the heating core and cooling channel of FIG. 6E can be reversed, with a heating structure disposed around a central cooling channel. This reduces material costs as a separate cooling channel wall would not be required, but at the expense of reduces cooling directly to the cooktop.

FIG. 7 shows a schematic view of a heating and cooling system 200 according to at least some embodiments of the present invention. In this system 200, when a temperature controller 231a or 231b in control area 230 is set to a desired temperature level, signals 236a or 236b, respectively, are sent to a central processor 201. Central processor 201 sends signals 210a or 210b to heat the respective burner locations 222a or 222b, and monitors the temperatures of the burner locations via signal paths 212a and 212b. If the burner locations are hotter than the selected temperature, central processor 201 can actuate a valve mechanism 240 through signal path 216 and direct a cooling device 270 via signal path 217 to provide a predetermined amount of cooling (typically by providing a predetermined flow rate of air of liquid) through cooling conduit 260 and into a manifold 264 or 266 accessible through the valve mechanism 240.

In some embodiments, cooling device 270 can provide both cooling and heating air or fluid through conduit 260, which can speed both heating and cooling of the burner locations 222a and 222b depending on the needs of the system. For example, if cooling device 270 were a heat pump device, the same device would be able to provide both heating and cooling. In some examples, multiple cooling devices 270, or a combination of cooling devices and heating devices can be employed to independently heat and/or cool various burner locations at the same time and at different heat transfer rates.

In some examples, cooling device 270 can be a fan or compressor that delivers room air at various flow rates for cooling. In other examples, cooling device 270 can be an air conditioner that supplies cooled air. In other examples, cooling device can be a refrigeration cycle that provides liquid or gaseous refrigerant to the burner locations in order to heat or cool the locations. The cooling device 270 (or multiple cooling devices) may reside in the electrical cooktop assembly, or can be fully or partially separate from the assembly, such as in a mini-split type system with a compressor outside.

FIG. 8 shows an electric cooktop assembly 510 having a cooktop 520, a control panel 530, and base 540. Cooktop 520 has defined thereon burner opening 521 that are heated by actuation of heating elements 522 via respective temperature controllers 532 on control panel 530. While the example illustrated in FIG. 8 shows rotary selectors, other temperature controller interfaces known in the art are contemplated hereunder, including sliders, capacitive switches, touchscreens, remote computer interfaces, etc. In some embodiments, air is introduced into the electric cooktop assembly via air inlet 560, and exits the electric cooktop assembly through a vent 550 extending through the cooktop 20.

FIG. 9A shows heating element 580 according to an example embodiment. Heating element 580 includes a single coiled element segment 581 having an upper surface 582 that is adjacent an area to be heated, such as the underside of a cooking vessel. Heating element 580 may include connectors 583A and 583B that interface with the electric cooktop assembly 510 through interface 590 to provide a cooling fluid and electricity to the heating element 580. Heating element 580 has cross section 588a, shown magnified in FIG. 9B.

FIG. 9B shows an interface 590 that includes a fluid inlet 592 for providing cooling fluid to one side of a fluid channel 587a through which it flows and exits into fluid outlet 593 of interface 590. Similarly, interface 590 includes electrical terminals 599 that provide heating core connections 589a of the heating element 580 with a voltage to produce heat through the heating element 580.

FIG. 9C shows an alternative cross section 588b that has the heating core 589b within and surrounded by cooling channel 587b. This cross section 588b is arranged to interface a complementary interface connection 590b (which is the same for both terminals) having electrical connection 595 that connects to heating core 589b, and air supply 594 that supplies cooling fluid through cooling conduit 587b. Electrical connection 595 exits a side of air supply 594 to connect to an electricity source, and air supply 594 connects to a cooling fluid source.

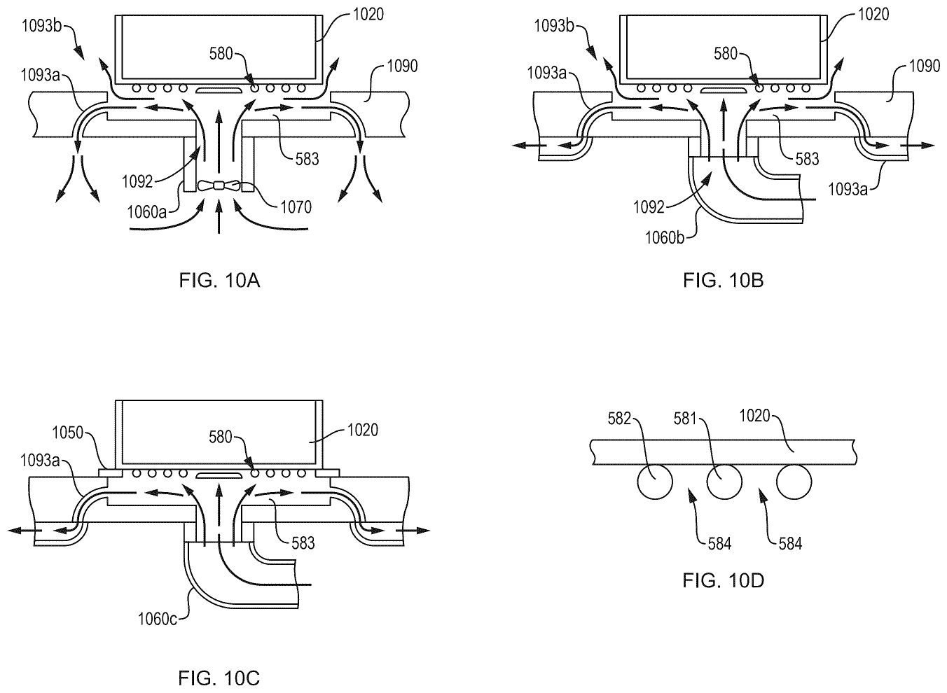

FIGS. 10A-10D show examples an air flow routes through an electric cooktop assembly. Air within supply line 1060 is selectively allowed to enter air space 583 beneath the burner 520 through air inlet 1092. Air introduced into air space 583 is directed toward heating element 580.

In FIG. 10A, a fan 1070 pushes air through supply line 1060a and into air space 583 toward heating element 580. The air captures heat from the heating element 580 as well as the underside of cooking vessel 1020, and then exits through air outlets 1093a as well as through a gap 1093b between a cooktop 1090 and the cooking vessel 1020.

In FIG. 10B, supply line 1060b is connected to an external cooling fluid supply that is then directed through air inlet 1092, where it flows through air outlets 1093a and gaps 1093b as in FIG. 10A. FIG. 10C is the same as FIG. 10B, but has a shield 1050 that keeps air flow beneath the cooktop 1090, only exiting through air outlet 1093a.

FIG. 10D is similar to FIG. 4B, but instead of having air channels 95a/95b being enclosed on four sides, the channels 584 of FIG. 10D are only enclosed on three sides, by the bottom surface of cooking vessel 1020 on an upper portion of the channel, and adjacent portions of segment 581, which have upper surface 582 in contact with the bottom surface of cooking vessel 1020 to substantially create a seal, allowing for air directed thereat to flow along the element 581 and cooking vessel 1020 to remove heat therefrom.

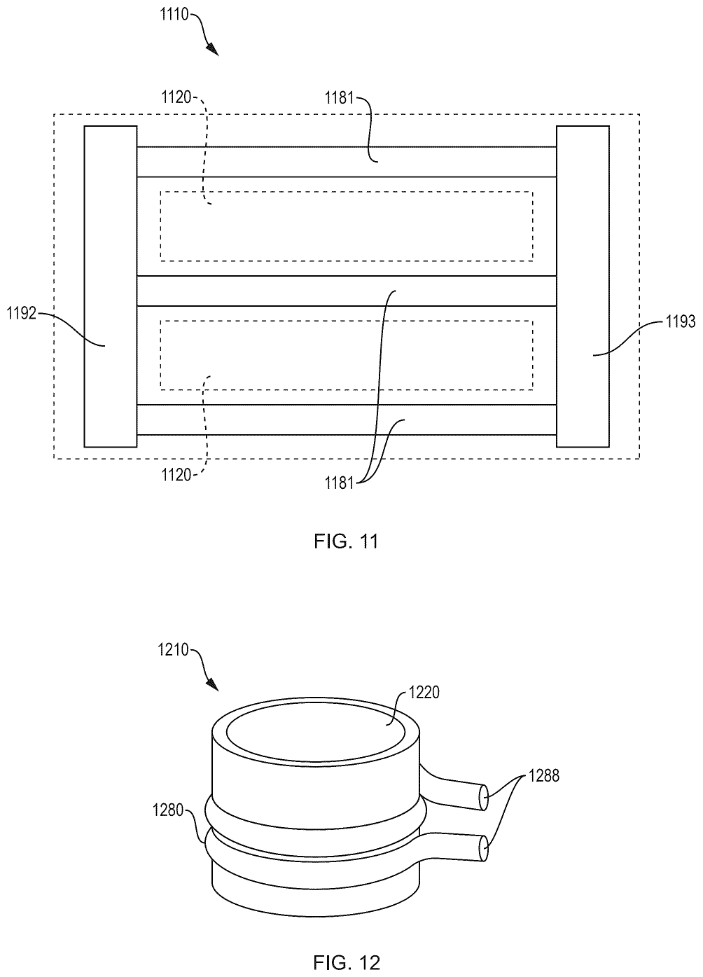

FIG. 11 shows another use case for cooled heating elements 1181 in a toaster 1110 having cooking slots 1120 flanked by heating elements 1181 that are supplied on one side with an air inlet manifold 1192 that can send cooling fluid through heating elements 1181 on one or both sides of the toaster 1110, and air outlet manifold 1193 that can receive the air sent through the heating elements 1181.

FIG. 12 shows another use case for cooled heating elements 1280 in a cylindrical heating vessel 1210 that requires dynamic temperature adjustment for particular purposes, such as a crucible for heating or melting objects that requires precise heating and cooling rates, an open cylinder for selectively heating a portion of elongated object, an espresso group head for cooling a portion of an espresso shot, or a beverage container for rapidly cooling a hot beverage to drinking temperatures. Cylindrical heating vessel 1220 includes a cylindrical heating area 1220 wrapped with a heating element 1280. Heating element 1280 includes a cross section 1288 that can be interfaced as described above to allow flow of cooling fluid and electricity therethrough.

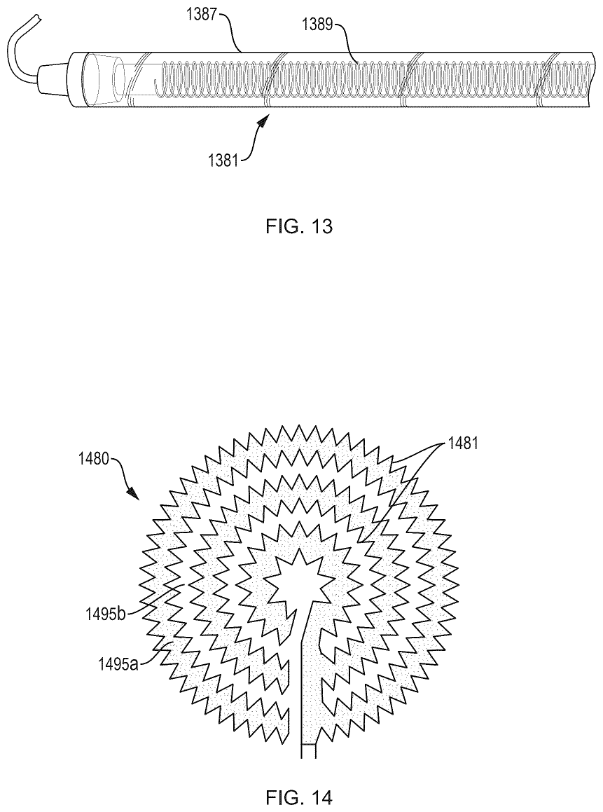

FIG. 13 shows an example of a heating element 1381 that has a coiled inner heating core 1389 and a glass cooling chamber 1387 enclosing the heating core 1389. A cooling fluid can flow through the cooling chamber 1378 to directly cool the heating core 1389 as well as air or objects contacting the exterior of cooling chamber 1387.

FIG. 14 shows an alternate shape for a heating element 1480 having corrugated segments 1481 that are coiled to create channels 1495a and 1495b that can be fed by separate air inlets and outlets similar to the elements 80 of FIG. 4A.

In some examples, the time for cooling is internally pre-programed while in other instances the temperature of the heating element is monitored via a sensor and sufficient cooling is applied to the heating element until the heating element reaches the desired temperature.

In some examples, cool air is used for cooling as above, and exhaust air temperature is monitored via a temperature sensor to determine the appropriate temperature adjustments required.

In some examples, air or a compressed liquid may be used in either an open or a closed loop system.

The heating and cooling elements should be made of a substance the can withstand the temperatures that would be expected during heating and cooling. The shape of the heating and cooling elements can be smooth, spiraled, crimped, or be some combination thereof depending on the desired use case.

Having described the invention it should be understood that the foregoing description of the invention is intended merely to be illustrative thereof and that other modifications, embodiments and equivalents may be apparent to those who are skilled in the art without departing from its spirit.

The present invention is not intended to be limited to a device or method which must satisfy one or more of any stated or implied objects or features of the invention and should not be limited to the preferred, exemplary, or primary example(s) described herein. Modifications and substitutions by one of ordinary skill in the art are considered to be within the scope of the present invention, which is not to be limited except by the allowed claims and their legal equivalents.

The invention claimed is:

1. An electric cooktop assembly comprising:
a cooktop having defined burner locations;
a heating assembly, disposed adjacent to each defined burner location, the heating assembly including:
one or more heating elements having a plurality of heating segments;
an element housing having at least one cooling fluid inlet and at least one cooling fluid outlet; and
a cooling fluid conduit in fluid communication with the at least one cooling fluid inlet for selectively providing said cooling fluid adjacent the plurality of heating segments;
a temperature controller, for setting a desired temperature at a burner location; and
a cooling device, responsive to said temperature controller, for selectively providing said cooling fluid to said cooling fluid conduit based upon the set temperature of said temperature controller.

2. The electric cooktop assembly of claim 1, wherein the cooling fluid is selected from the group of cooling fluids consisting of air, vapor, and liquid.

3. An electric cooktop assembly comprising:
a cooktop having defined burner locations;
a heating assembly, disposed adjacent to each defined burner location, the heating assembly including:
a heating element having a plurality of heating segments;
an element housing having at least one air inlet and at least one air outlet; and
an air conduit in fluid communication with the at least one air inlet for selectively providing air adjacent the plurality of heating segments;
a temperature controller for setting a desired temperature at a burner location; and
a cooling device for selectively providing air to the air conduit based upon the set temperature.

4. A cooled electric heating assembly comprising:
a heating element having an electric heating core; and
a forced-fluid cooling device having a fluid circulator, for providing a cooling fluid, one or more fluid inlets for directing, along the electric heating core, a flow of cooling fluid from the fluid circulator, and a fluid outlet for directing cooling fluid away from the heating core.

5. The cooled electric heating element of claim 4, wherein the cooling fluid is selected from the group of cooling fluids consisting of air, vapor, and liquid.

6. The cooled electric heating element of claim 4, wherein the forced-fluid cooling device is selected from the group of forced-fluid cooling devices consisting of a fan, a heat exchanger, an air conditioner, and refrigerator.

7. The cooled electric heating element of claim 4, wherein the one or more fluid inlets directs cooling fluid through a channel that substantially surrounds the perimeter of the heating core.
